(19) United States
(12) Patent Application Publication
(10) Pub. No.: US 2017/0175975 A1
(43) Pub. Date: Jun. 22, 2017

(54) METHOD AND APPARATUS FOR AN ASYMMETRIC OPTICAL LENS

(71) Applicant: PHILIPS LIGHTING HOLDING B.V., EINDHOVEN (NL)

(72) Inventor: Luc Guy Louis LACROIX, EINDHOVEN (NL)

(73) Assignee: PHILIPS LIGHTING HOLDING B.V., EINDHOVEN (NL)

(21) Appl. No.: 15/129,651

(22) PCT Filed: Mar. 23, 2015
(86) PCT No.: PCT/IB2015/052095

§ 371 Date: Sep. 27, 2016

Related U.S. Application Data
(60) Provisional application No. 61/971,099, filed on Mar. 27, 2014.

(51) Int. Cl. F21V 5/08; F21V 13/02; F21K 9/69; F21V 5/00

(52) U.S. Cl. CPC F21V 5/08; F21V 5/007; F21V 13/02; F21K 9/69; F21Y 2115/10

(57) ABSTRACT

In various embodiments, an asymmetric optical lens (100) may include a proximal volume (102). The proximal volume may include a base surface (106) and an LED recess (108) shaped to receive light emitted by one or more LEDs (109) along a first central light output axis (112). The LED recess may guide the received light along a second central light output axis (110) that is at a first angle (φ) relative to the first central light output axis. The asymmetric optical lens may also include a distal volume (104) that includes, opposite the base surface, a non-planar light emission surface (114). The distal volume may be shaped to guide light from the proximal portion through the light emission surface along a third central light output axis (116) that is at a second angle (λ) to the first central light output axis. The second angle may be greater than the first.

### TECHNICAL FIELD

The present invention is directed generally to lighting control. More particularly, various inventive methods and apparatus disclosed herein relate to lenses and methods of using lenses to illuminate inflated optical membranes.

### BACKGROUND

Digital lighting technologies, i.e., illumination based on semiconductor light sources, such as light-emitting diodes (LEDs), offer a viable alternative to traditional fluorescent, HID, and incandescent lamps. Functional advantages and benefits of LEDs include high energy conversion and optical efficiency, durability, lower operating costs, and many others. Recent advances in LED technology have provided efficient and robust full-spectrum lighting sources that enable a variety of lighting effects in many applications. Some of the fixtures embodying these sources feature a lighting module, including one or more LEDs capable of producing different colors, e.g., red, green, and blue, as well as a processor for independently controlling the output of the LEDs in order to generate a variety of colors and color-changing lighting effects, for example, as discussed in detail in U.S. Pat. Nos. 6,016,038 and 6,211,626, incorporated herein by reference.

Inflated optical membranes may be inflated, arranged and/or selectively illuminated to create various patterns, colors, and so forth. For example, a plurality of inflated optical membranes may be mounted on the exterior of a building such as a stadium to form a matrix of “pixels,” where each “pixel” is an inflated optical membrane. A light source such as a fluorescent lamp may be positioned adjacent each inflated optical membrane. Once the inflated optical membranes are inflated, the light sources may be selectively energized to illuminate selected inflated optical membranes. In some instances, colored lens (e.g., coated with phosphor(s)) may be mounted on the light sources to cause the emitted light to have a particular color. Such an arrangement is limited in its flexibility in that, among other things, the colors that may be emitted by each inflated optical membrane are limited by the number of lenses provided with the corresponding light source. Moreover, light sources typically used with inflated optical membranes, such as fluorescent or halogen lamps, may consume a large amount of energy. This problem is exacerbated when large numbers of inflated optical membranes are employed, each with its own light source.

Thus, there is a need in the art to provide more lighting flexibility in applications where inflated optical membranes are employed, as well as to make such applications more energy-efficient.

### SUMMARY

The present disclosure is directed to inventive methods and apparatus for an optical lens for redirecting and/or reshaping light emitted by one or more LEDs. For example, an asymmetric optical lens according to one embodiment may be configured to redirect light emitted by one or more LEDs in two phases, e.g., to retain the efficiency and/or color mixing of a standard direction projection beam. The first redirection may be induced by a LED recess formed in a distal volume of a lens. The LED recess may be shaped to redirect light emitted by one or more LEDs in a first direction that is different than a central light output axis of one or more LEDs. The second redirection may be induced by a distal volume of the lens that is shaped to redirect the light from the LED recess in a second direction that is different than both the first direction and the central light output axis of one or more LEDs. In some embodiments, an asymmetric optical lens configured with selected aspects of the present disclosure may be used to illuminate architectural features such as inflated optical membranes, e.g., mounted on the side of a building such as a stadium.

Generally, in one aspect, an asymmetric optical lens may include a proximal volume. The proximal volume may include a base surface and an LED recess formed in the base surface. The LED recess may be shaped to receive light emitted by one or more LEDs along a first central light output axis, and to guide the received light along a second central light output axis that is at a first non-parallel angle relative to the first central light output axis to form a first beam of light. The asymmetric optical lens may also include a distal volume. The distal volume may include, opposite the base surface, a non-planar light emission surface. The distal volume may be shaped to guide the first beam of light to form a second beam of light that is emitted from the light emission surface along a third central light output axis that is at a second non-parallel angle relative to the first central light output axis. The second non-parallel angle may be greater than the first non-parallel angle.

In various embodiments, the non-planar light emission surface includes an optical prescription. In various embodiments, the optical prescription includes an apex that formed between opposite sides of the light emission surface along a longitudinal axis of the asymmetric optical lens. In various versions, the apex is offset from a center of the non-planar light emission surface. In various versions, the light emission surface includes first and second portions that lie on opposite sides of a first line that divides the light emission surface crosswise in two, wherein the apex is on the first portion of the light emission surface.

In various versions, the first line is perpendicular to and extends across a midpoint of a second line that divides the light emission surface lengthwise in two. In various versions, the second line comprises a longest chord across a profile defined by the light emission surface. In various versions, the second portion of the light emission surface on an opposite side of the first line from the first portion projects out from a profile defined by the base surface farther than the first portion of the light emission surface when viewed from a point along a normal from the base surface. In various versions, the LED recess is shaped so that the second central light output axis passes through a point in the light emission surface that is on an opposite side of the first line from the LED recess. In various versions, the LED recess lies entirely within a profile defined by the first portion when viewed from a point along a normal from the base surface.

In various embodiments, a distance between the apex and the base surface along a normal to the base surface is between 10 mm and 11 mm. In various embodiments, a maximum distance across the light emission surface lengthwise is between 17.5 mm and 18.5 mm. In various embodiments, a maximum distance across the light emission surface crosswise is between 15 mm and 16 mm. In various embodiments, the second non-parallel angle is between 40° and 50°. In various embodiments, the second non-parallel angle is approximately 45°. In various embodiments, the second beam of light is wider than the first beam of light by a predetermined amount.

In another aspect, a method of illuminating an inflated optical membrane may include installing an asymmetric optical lens configured with selected aspects of the present disclosure adjacent the inflated optical membrane so that one or more LEDs lie within the LED recess; arranging the asymmetric optical lens so that the third central light output axis is pointed towards the inflated optical membrane; and selectively energizing the one or more LEDs to emit light having one or more selected properties.

In various embodiments, the installing includes installing the asymmetric optical lens between most of the inflated optical membrane and a ground surface. In various embodiments, the arranging includes arranging the asymmetric lens so that the third central light output axis is pointed generally upwards away from the ground surface.

As used herein for purposes of the present disclosure, the term “LED” should be understood to include any electroluminescent diode or other type of carrier injection/junction-based system that is capable of generating radiation in response to an electric signal. Thus, the term LED includes, but is not limited to, various semiconductor-based structures that emit light in response to current, light emitting polymers, organic light emitting diodes (OLEDs), electroluminescent strips, and the like. In particular, the term LED refers to light emitting diodes of all types (including semi-conductor and organic light emitting diodes) that may be configured to generate radiation in one or more of the infrared spectrum, ultraviolet spectrum, and various portions of the visible spectrum (generally including radiation wavelengths from approximately 400 nanometers to approximately 700 nanometers). Some examples of LEDs include, but are not limited to, various types of infrared LEDs, ultraviolet LEDs, red LEDs, blue LEDs, green LEDs, yellow LEDs, amber LEDs, orange LEDs, and white LEDs (discussed further below). It also should be appreciated that LEDs may be configured and/or controlled to generate radiation having various bandwidths (e.g., full widths at half maximum, or FWHM) for a given spectrum (e.g., narrow bandwidth, broad bandwidth), and a variety of dominant wavelengths within a given general color categorization.

For example, one implementation of an LED configured to generate essentially white light (e.g., a white LED) may include a number of dies which respectively emit different spectra of electroluminescence that, in combination, mix to form essentially white light. In another implementation, a white light LED may be associated with a phosphor material that converts electroluminescence having a first spectrum to a different second spectrum. In one example of this implementation, electroluminescence having a relatively short wavelength and narrow bandwidth spectrum “pumps” the phosphor material, which in turn radiates longer wavelength radiation having a somewhat broader spectrum.

It should also be understood that the term LED does not limit the physical and/or electrical package type of an LED. For example, as discussed above, an LED may refer to a single light emitting device having multiple dies that are configured to respectively emit different spectra of radiation (e.g., that may or may not be individually controllable). Also, an LED may be associated with a phosphor that is considered as an integral part of the LED (e.g., some types of white LEDs). In general, the term LED may refer to packaged LEDs, non-packaged LEDs, surface mount LEDs, chip-on-board LEDs, T-package mount LEDs, radial package LEDs, power package LEDs, LEDs including some type of encasement and/or optical element (e.g., a diffusing lens), etc.

The term “light source” should be understood to refer to any one or more of a variety of radiation sources, including, but not limited to, LED-based sources (including one or more LEDs as defined above), incandescent sources (e.g., filament lamps, halogen lamps), fluorescent sources, phosphorescent sources, high-intensity discharge sources (e.g., sodium vapor, mercury vapor, and metal halide lamps), lasers, other types of electroluminescent sources, pyro-luminescent sources (e.g., flames), candle-luminescent sources (e.g., gas mantles, carbon arc radiation sources), photo-luminescent sources (e.g., gaseous discharge sources), cathode luminescent sources using electronic satiation, galvano-luminescent sources, crystallo-luminescent sources, kine-luminescent sources, thermo-luminescent sources, triboluminescent sources, sonoluminescent sources, radioluminescent sources, and luminescent polymers.

A given light source may be configured to generate electromagnetic radiation within the visible spectrum, outside the visible spectrum, or a combination of both. Hence, the terms “light” and “radiation” are used interchangeably herein. Additionally, a light source may include as an integral component one or more filters (e.g., color filters), lenses, or other optical components. Also, it should be understood that light sources may be configured for a variety of applications, including, but not limited to, indication, display, and/or illumination. An “illumination source” is a light source that is particularly configured to generate radiation having a sufficient intensity to effectively illuminate an interior or exterior space. In this context, “sufficient intensity” refers to sufficient radiant power in the visible spectrum generated in the space or environment (the unit “lumens” often is employed to represent the total light output from a light source in all directions, in terms of radiant power or “luminous flux”) to provide ambient illumination (i.e., light that may be perceived indirectly and that may be, for example, reflected off of one or more of a variety of intervening surfaces before being perceived in whole or in part).

The term “spectrum” should be understood to refer to any one or more frequencies (or wavelengths) of radiation produced by one or more light sources. Accordingly, the term “spectrum” refers to frequencies (or wavelengths) not only in the visible range, but also frequencies (or wavelengths) in the infrared, ultraviolet, and other areas of the overall electromagnetic spectrum. Also, a given spectrum may have a relatively narrow bandwidth (e.g., a FWHM having essentially few frequency or wavelength components) or a relatively wide bandwidth (several frequency or wavelength components having various relative strengths). It should also be appreciated that a given spectrum may be the result of a mixing of two or more other spectra (e.g., mixing radiation respectively emitted from multiple light sources).

For purposes of this disclosure, the term “color” is used interchangeably with the term “spectrum.” However, the term “color” generally is used to refer primarily to a property of radiation that is perceivable by an observer (although this usage is not intended to limit the scope of this term). Accordingly, the terms “different colors” implicitly refer to multiple spectra having different wavelength components and/or bandwidths. It also should be appreciated that the term “color” may be used in connection with both white and non-white light.

The term “color temperature” generally is used herein in connection with white light, although this usage is not intended to limit the scope of this term. Color temperature essentially refers to a particular color content or shade (e.g., reddish, bluish) of white light. The color temperature of a given radiation sample conventionally is characterized according to the temperature in degrees Kelvin (K) of a black body radiator that radiates essentially the same spectrum as the radiation sample in question. Black body radiator color temperatures generally fall within a range of approximately 700 degrees K (typically considered the first visible to the human eye) to over 10,000 degrees K; white light generally is perceived at color temperatures above 1500-2000 degrees K.

Lower color temperatures generally indicate white light having a more significant red component or a “warmer feel,” while higher color temperatures generally indicate white light having a more significant blue component or a “cooler feel.” By way of example, fire has a color temperature of approximately 1,800 degrees K, a conventional incandescent bulb has a color temperature of approximately 2848 degrees K, early morning daylight has a color temperature of approximately 3,000 degrees K, and overcast midday skies have a color temperature of approximately 10,000 degrees K. A color image viewed under white light having a color temperature of approximately 3,000 degree K has a relatively reddish tone, whereas the same color image viewed under white light having a color temperature of approximately 10,000 degrees K has a relatively bluish tone.

The term “lighting fixture” is used herein to refer to an implementation or arrangement of one or more lighting units in a particular form factor, assembly, or package. The term “lighting unit” is used herein to refer to an apparatus including one or more light sources of same or different types. A given lighting unit may have any one of a variety of mounting arrangements for the light source(s), enclosure/housing arrangements and shapes, and/or electrical and mechanical connection configurations. Additionally, a given lighting unit optionally may be associated with (e.g., include, be coupled to and/or packaged together with) various other components (e.g., control circuitry) relating to the operation of the light source(s). An “LED-based lighting unit” refers to a lighting unit that includes one or more LED-based light sources as discussed above, alone or in combination with other non LED-based light sources. A “multi-channel” lighting unit refers to an LED-based or non LED-based lighting unit that includes at least two light sources configured to respectively generate different spectrums of radiation, wherein each different source spectrum may be referred to as a “channel” of the multi-channel lighting unit.

The term “controller” is used herein generally to describe various apparatus relating to the operation of one or more light sources. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, floppy disks, compact disks, optical disks, magnetic tape, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

The term “addressable” is used herein to refer to a device (e.g., a light source in general, a lighting unit or fixture, a controller or processor associated with one or more light sources or lighting units, other non-lighting related devices, etc.) that is configured to receive information (e.g., data) intended for multiple devices, including itself, and to selectively respond to particular information intended for it. The term “addressable” often is used in connection with a networked environment (or a “network,” discussed further below), in which multiple devices are coupled together via some communications medium or media.

In one network implementation, one or more devices coupled to a network may serve as a controller for one or more other devices coupled to the network (e.g., in a master/slave relationship). In another implementation, a networked environment may include one or more dedicated controllers that are configured to control one or more of the devices coupled to the network. Generally, multiple devices coupled to the network each may have access to data that is present on the communications medium or media; however, a given device may be “addressable” in that it is configured to selectively exchange data with (i.e., receive data from and/or transmit data to) the network, based, for example, on one or more particular identifiers (e.g., “addresses”) assigned to it.

The term “network” as used herein refers to any interconnection of two or more devices (including controllers or processors) that facilitates the transport of information (e.g., for device control, data storage, data exchange, etc.) between any two or more devices and/or among multiple devices coupled to the network. As should be readily appreciated, various implementations of networks suitable for interconnecting multiple devices may include any of a variety of network topologies and employ any of a variety of communication protocols. Additionally, in various networks according to the present disclosure, any one connection between two devices may represent a dedicated connection between the two systems, or alternatively a non-dedicated connection. In addition to carrying information intended for the two devices, such a non-dedicated connection may carry information not necessarily intended for either of the two devices (e.g., an open network connection). Furthermore, it should be readily appreciated that various networks of devices as discussed herein may employ one or more wireless, wire/cable, and/or fiber optic links to facilitate information transport throughout the network.

The term “user interface” as used herein refers to an interface between a human user or operator and one or more devices that enables communication between the user and the device(s). Examples of user interfaces that may be employed in various implementations of the present disclosure include, but are not limited to, switches, potentiometers, buttons, dials, sliders, a mouse, keyboard, keypad, various types of game controllers (e.g., joysticks), track balls, display screens, various types of graphical user interfaces (GUIs), touch screens, microphones and other types of sensors that may receive some form of human-generated stimulus and generate a signal in response thereto.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention.

FIG. 1 is a perspective view of an example asymmetric optical lens, in accordance with various embodiments.

FIG. 2 is a side view of a cross section of the asymmetric optical lens of FIG. 1, in accordance with various embodiments.

FIG. 3 is a bottom perspective view of the asymmetric optical lens of FIGS. 1-2, in accordance with various embodiments.

FIG. 4 is a front view of the asymmetric optical lens of FIGS. 1-3, in accordance with various embodiments.

FIG. 5 is a top view of the asymmetric optical lens of FIGS. 1-4, in accordance with various embodiments.

FIG. 6 is a schematic side view showing how an asymmetric optical lens configured with selected aspects of the present disclosure may redirect light, in accordance with various embodiments.

FIG. 7 depicts one example of how an asymmetric optical lens configured with selected aspects of the present disclosure may be employed to illuminate an inflated optical membrane, in accordance with various embodiments.

FIG. 8 depicts one example of how a plurality of asymmetric optical lenses configured with selected aspects of the present disclosure may be employed to illuminate an inflated optical membrane, in accordance with various embodiments.

### DETAILED DESCRIPTION

Inflated optical membranes may be arranged and/or selectively illuminated to create various patterns, colors, and so forth. A light source such as a fluorescent lamp may be positioned adjacent each inflated optical membrane so that when energized, the light source illuminates the inflated optical membrane. In some instances, various optical elements such as colored lens may be employed to cause the emitted light to have a particular characteristic. Such an arrangement is limited in its flexibility. Moreover, light sources typically used with inflated optical membranes, such as fluorescent or halogen lamps, may consume a large amount of energy. Thus, there is a need in the art to provide more lighting flexibility in applications where inflated optical membranes are employed, as well as to make such applications more energy-efficient. More generally, Applicants have recognized and appreciated that it would be beneficial to provide a lens that redirects light from an LED-based light source in two phases, e.g., to maintain efficiency and color mixing.

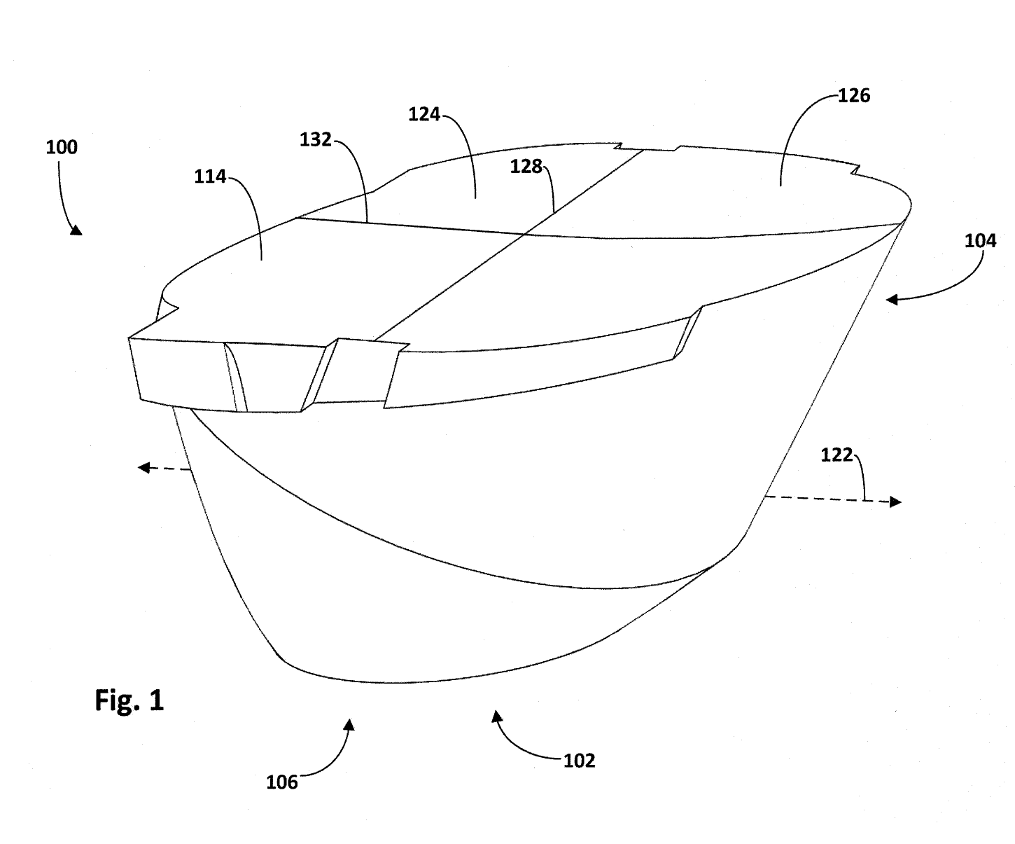

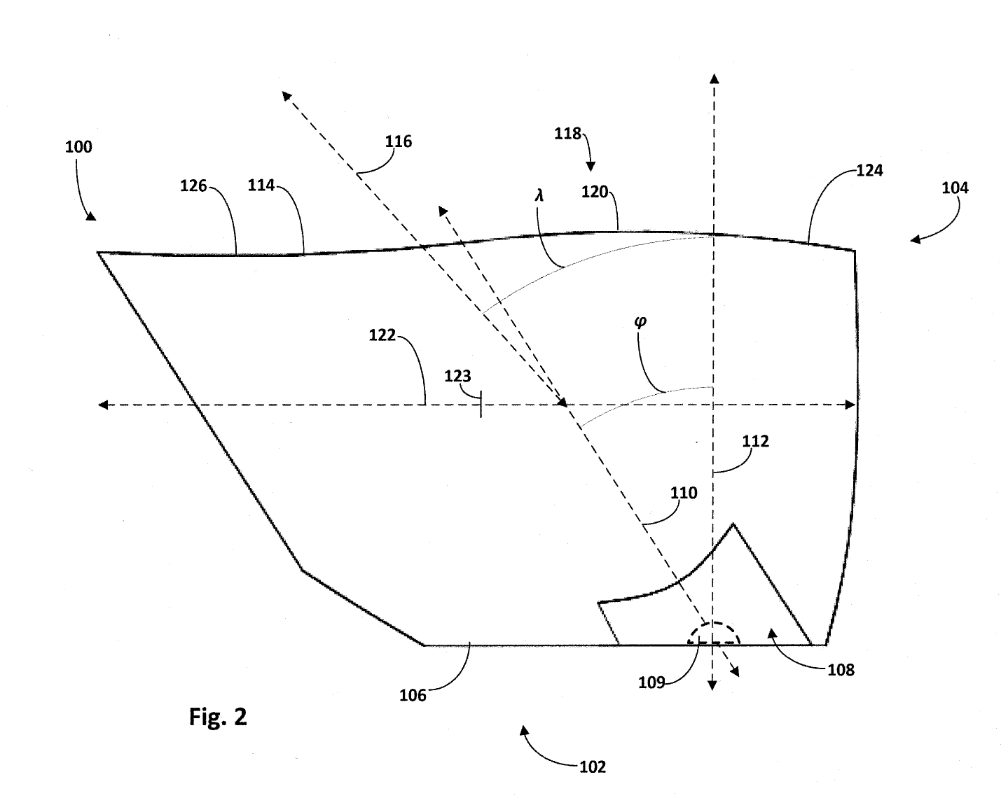

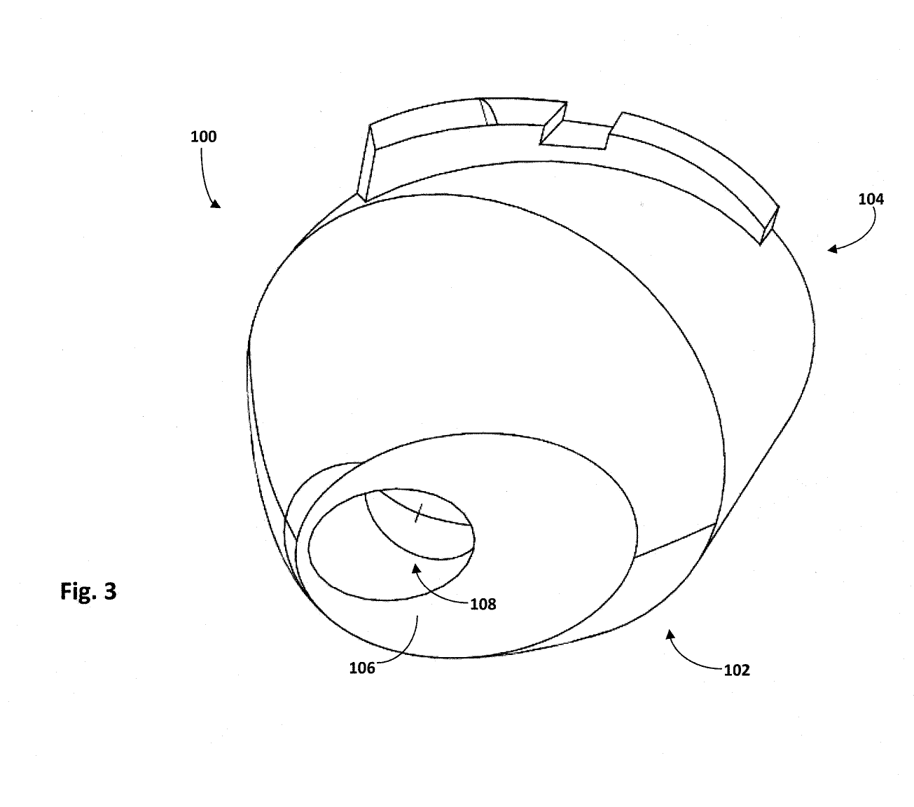

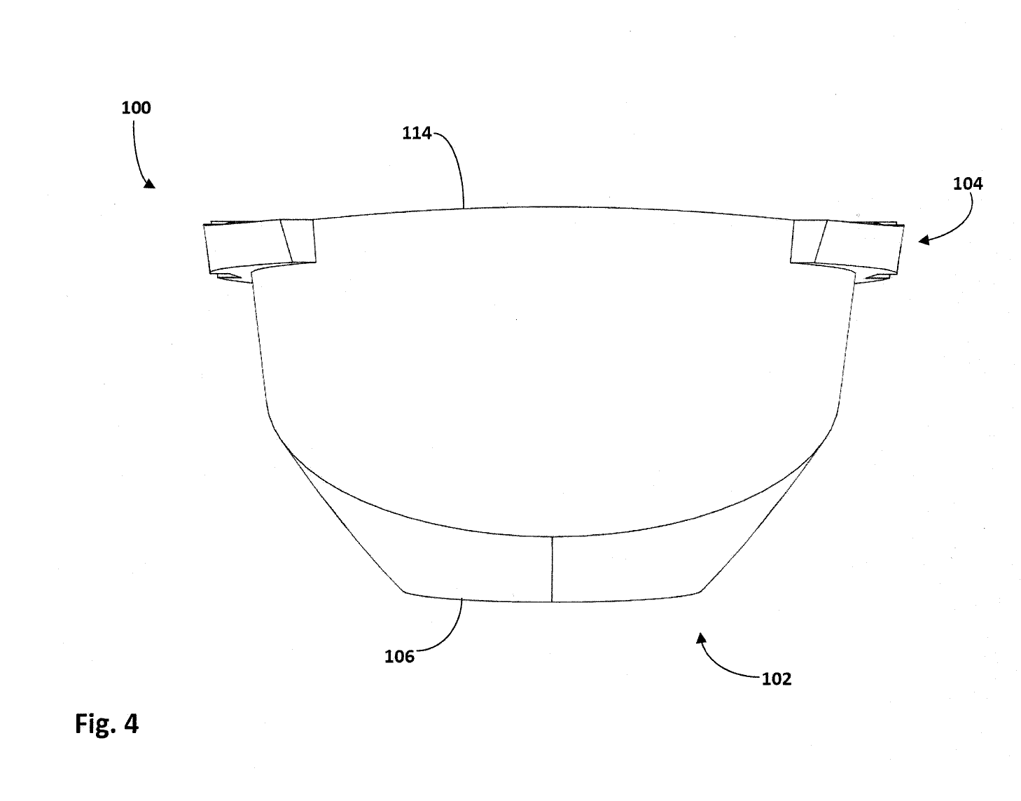

Referring to FIGS. 1-5, in one embodiment, an asymmetric optical lens 100 may include a proximal volume 102 and a distal volume 104. A base surface 106 may be formed in proximal volume 102. An LED recess 108 (see FIGS. 2 and 3) may be formed in base surface 106. In various embodiments, LED recess 108 may be shaped to guide light emitted by one or more LEDs (depicted in phantom of FIG. 2 at 109) along second central light output axis 110. In various embodiments, second central light output axis 110 may be at a first non-parallel angle, φ, relative to a first central light output axis 112 of one or more LEDs.

Distal volume 104 may include, opposite base surface 106, a non-planar light emission surface 114. Distal volume 104 may be shaped to guide a first beam of light received from LED recess 108 to form a second beam of light. The second beam of light ultimately may be emitted from light emission surface 114. In various embodiments, the second beam of light may be wider than the first beam of light by various amounts, such as by 15° or 20°. The second beam of light may have a third central light output axis 116 that may be at a second non-parallel angle, λ, relative to first central light output axis 112. In various embodiments, the second non-parallel angle λ between third central light output axis 116 and first central light output axis 112 may be greater than the first non-parallel angle φ between second central light output axis 110 and first central light output axis 112.

In various embodiments, non-planar light emission surface 114 may include an optical prescription. In some embodiments, non-planar light emission surface 114 may be textured, e.g., to distribute light uniformly. In some embodiments, the optical prescription may be selected to cause light emitted through light emission surface 114 to have various characteristics. For example, in some embodiments, the optical prescription may include a slightly raised portion 118 (see, e.g., FIG. 2) that rises from light emission surface 114 to form an apex 120 between opposite sides of light emission surface 114 along a longitudinal axis 122 of asymmetric optical lens 100. In some embodiments, apex 120 may be offset from a center 123 of longitudinal axis 122.

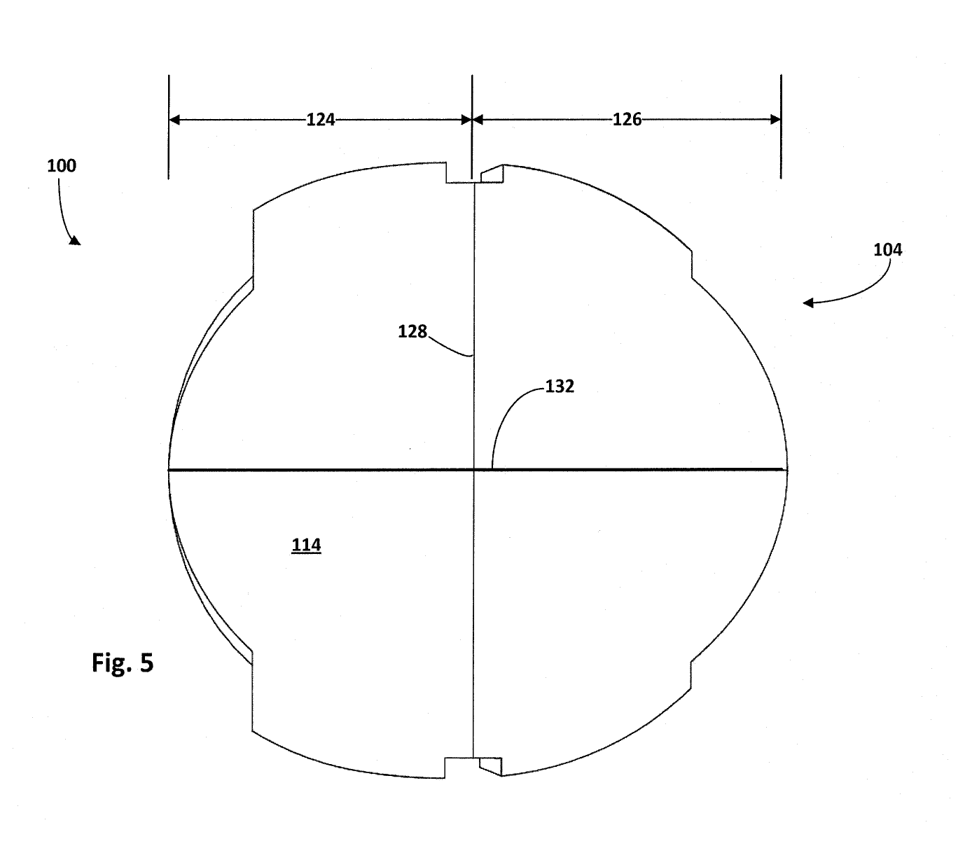

In various embodiments, light emission surface 114 may include first and second portions 124 and 126, respectively, that lie on opposite sides of a first line 128 (see FIGS. 1 and 5) that divides light emission surface 114 crosswise in two. In some embodiments, first portion 124 may comprise approximately half of light emission surface 114 and second portion 126 may comprise the other half, although this is not required. In some embodiments, first line 128 is perpendicular to and extends across a second line 132 that divides light emission surface 114 lengthwise in two. In some embodiments, second line 132 runs parallel to longitudinal axis 122, and may be a longest chord across a profile defined by light emission surface 114. Although shown in FIGS. 1 and 5, in various embodiments, first line 128 and/or second line 132 may or may not be visible in an actual lens embodying selected aspects of the present disclosure.

In some embodiments, apex 120 may be located on first portion 124 of light emission surface 114. In various embodiments, second portion 126 of light emission surface 114 on an opposite side of first line 128 from first portion 124 may project out from a profile defined by base surface 106 farther than first portion 124 of light emission surface 114 when viewed from a point along a normal from base surface 106. In some embodiments, a terminal end of second portion 126 may raise slightly, such that asymmetric optical lens 100 on the same side of first line 128 as second portion 126 may resemble a bow of a ship.

In various embodiments, and as shown best in FIG. 2, LED recess 108 may lie entirely within a profile defined by first portion 124 when viewed from a point along a normal from base surface 106. In some embodiments, LED recess 108 may be shaped so that second central light output axis 110 passes through a point in light emission surface 114 that is on an opposite side of first line 128 from LED recess 108.

Asymmetric optical lens 100 and its various components may have various proportions, sizes, and so forth. For example, in various embodiments, a distance between apex 120 and base surface 106 along a normal to base surface 106 may be between 10 mm and 11 mm. In some embodiments, a maximum distance across light emission surface 114 lengthwise, e.g., parallel to longitudinal axis 122 and/or second line 132, is between 17.5 mm and 18.5 mm. In various embodiments, a maximum distance across light emission surface 114 crosswise, e.g., parallel to first line 128, is between 15 mm and 16 mm. In various embodiments, the angle λ between third central light output axis 116 and first central light output axis 112 may be between 40° and 50°, such as approximately 45°.

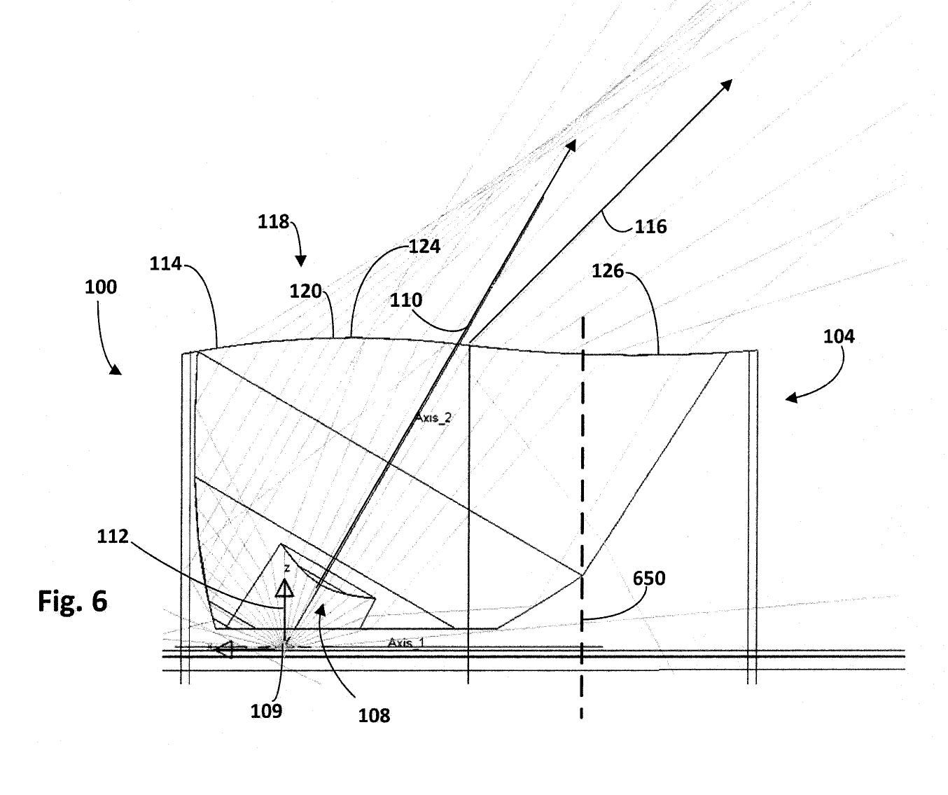

FIG. 6 depicts light rays that may be produced by an asymmetric optical lens 100 configured with selected aspects of the present disclosure. In some embodiments, asymmetric optical lens 100 may be truncated, e.g., so that the portion to the right of line 600 is cut off. This may result in some loss of output lumens, but may otherwise accomplish one or more advantages of various embodiments of the present disclosure.

FIG. 6 best depicts how light emitted from LED-based light source 109 may be redirected in two phases. Light emitted from LED-based light source 109 may initially be emitted to travel along first central light output axis 112 (i.e. the Z-axis in FIG. 6). However, LED recess 108 may be shaped, and its interior surfaces may have various levels of reflectivity, to redirect the light emitted from LED-based light source 109 in the direction of second central light output axis 110, e.g., as a first beam of light.

Distal volume 104 may be shaped to receive the first beam of light travelling along second central light output axis 110 and redirect it along third central light output axis 116, e.g., as a second beam of light. An internal reflectivity and/or shape of distal volume 104, and/or an optical prescription of light emission surface 114, may be selected to determine an angle between third central light output axis 116 and first central light output axis 112, as well as an angle between third central light output axis 116 and second central light output axis 110. The internal reflectively and/or shape of distal volume 104, as well as the optical prescription of light emission surface 114, may also be selected to cause the second beam of light (emitted from light emission surface 114) to be wider than the first beam of light (emitted from LED recess 108), e.g., by 15° or 20°.

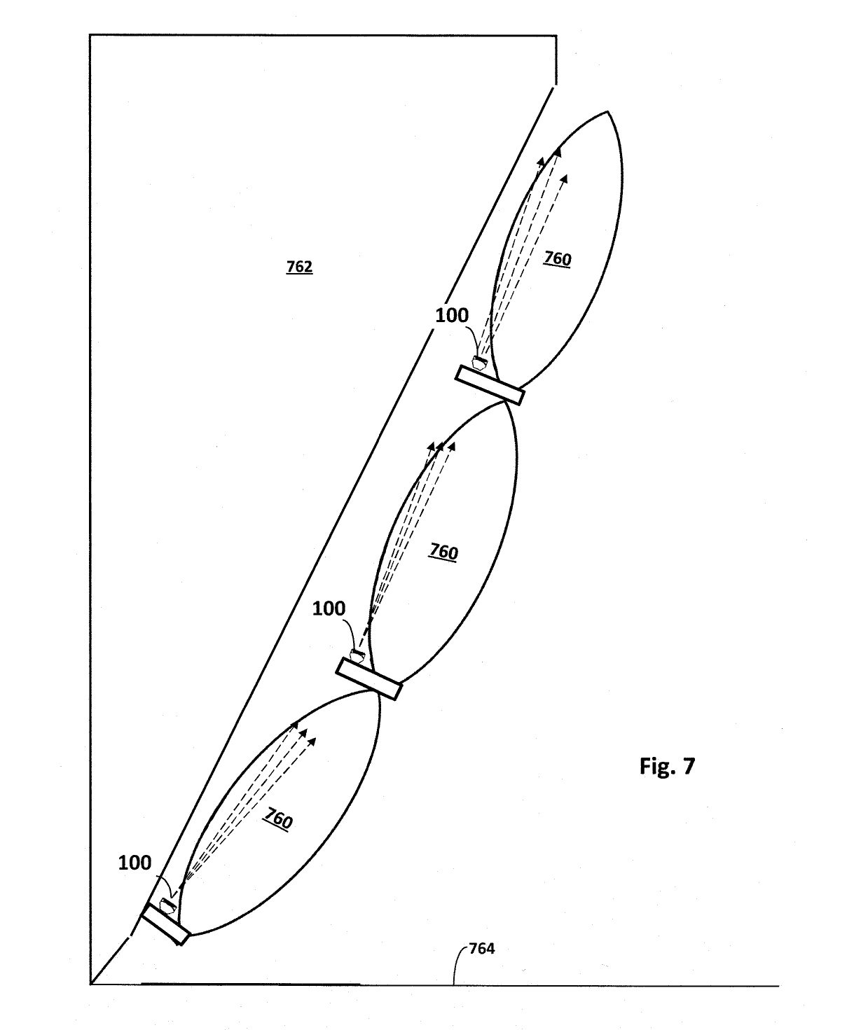

FIG. 7 depicts one example of how asymmetric optical lenses 100 configured with selected aspects of the present disclosure may be deployed to illuminate one or more inflated optical membranes 760 mounted on or near a surface of a building 762. The dashed arrows illustrate how light emitted through an asymmetric optical lens 100 may be directed towards inflated optical membranes 760 so that the membranes are illuminated, e.g., as evenly as possible, while light directly emitted from asymmetric optical lenses 100 is not visible to a passerby on a surface 764 below. In various embodiments, inflated optical membranes 760 may be constructed with various materials, including but not limited to Ethylene tetrafluoroethylene (“ETFE”) film. ETFE used may be transparent, matte, white, UVC, print (e.g., with silver patterns (dots or squares) printed with special ink to control light and heat transmission), and so forth.

In various embodiments, a plurality of inflated optical membranes 760 may be arranged in a two- and/or three-dimensional matrix. Each inflated optical membrane 760 may be illuminate-able with an asymmetric optical lens 100 according to the present disclosure. The LEDs deployed with each asymmetric optical lens 100 may be capable of individually producing light having various lighting characteristics, such as various hues, saturations, brightness levels, color temperatures, and so forth. For instance, in some embodiments, inflated optical membranes 760 may be used as “pixels,” and may be selectively illuminated so that collectively, they produce a still or animated image, or other dynamic effects (e.g., waves, flashing, twinkling, colors to match a particular holiday or event, and so forth). In some embodiments, RGB and/or RGBW LEDs may be employed.

In FIG. 7, it appears as though a single asymmetric optical lens 100 is deployed for each inflated optical membrane 760. However, this is not necessarily the case. In some embodiments, a row of asymmetric optical lenses (and accompanying LED light sources) may be arranged to illuminate a single optical membrane 760. For instance, in FIG. 7, it is contemplated that behind each visible asymmetric optical lens 100 there may be a plurality of asymmetric optical lenses 100 that are simply not visible in FIG. 7 because they are concealed behind the asymmetric optical lens that is visible.

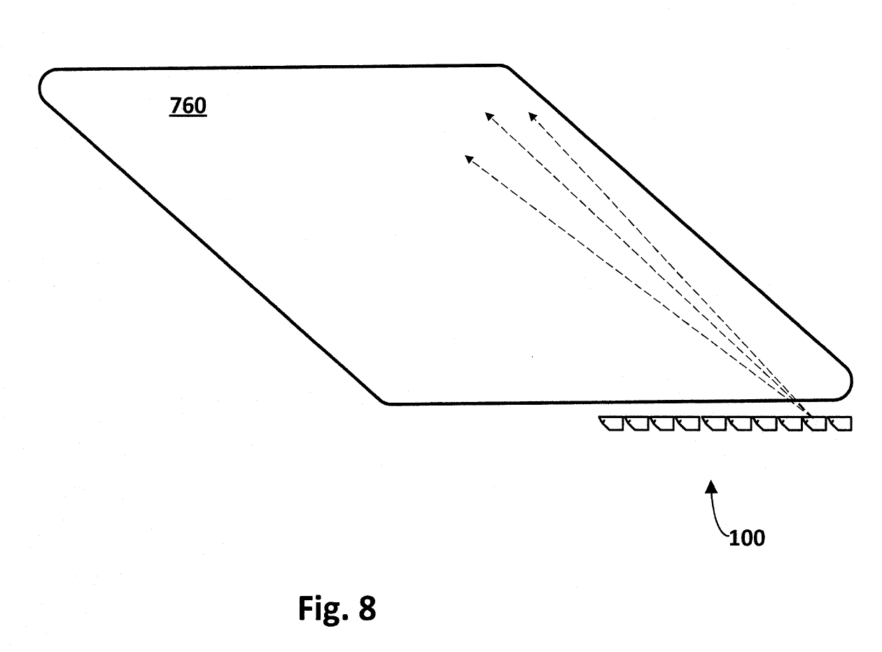

FIG. 8 depicts one example of how a plurality of asymmetric optical lenses 100 configured with selected aspects of the present disclosure may be deployed to illuminate a single inflated optical membrane 760. This is not meant to be limiting, however, and other configurations are contemplated. In some embodiments, each asymmetric optical lens 100 may be used to selectively illuminate inflated optical membrane 760 with a different color, e.g., to collectively achieve a variety of colors of illumination. In other instances, each asymmetric optical lens 100 may be used to emit light of the same color.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. An asymmetric optical lens for illumination of an optical membrane, comprising:
a proximal volume that includes a base surface and an LED recess formed in the base surface, the LED recess shaped to receive light emitted by one or more LEDs along a first central light output axis, and to guide the received light along a second central light output axis that is at a first non-parallel angle (φ) relative to the first central light output axis to form a first beam of light;
a distal volume that includes, opposite the base surface, a non-planar light emission surface, wherein the distal volume is shaped to guide the first beam of light to form a second beam of light that is emitted from the light emission surface along a third central light output axis that is at a second non-parallel angle (λ) relative to the first central light output axis, wherein the second non-parallel angle is greater than the first non-parallel angle,
wherein the optical membrane has a three-dimensional shape,
wherein the asymmetric optical lens is disposed adjacent to the optical membrane so that one or more LEDs lie within the LED recess, and the asymmetric optical lens is arranged so that the third central light output axis is pointed towards the optical membrane.

2. The asymmetric optical lens of claim 1, wherein the non-planar light emission surface includes an optical prescription.

3. The asymmetric optical lens of claim 2, wherein the optical prescription includes an apex that formed between opposite sides of the light emission surface along a longitudinal axis of the asymmetric optical lens.

4. The asymmetric optical lens of claim 3, wherein the apex is offset from a center of the non-planar light emission surface.

5. The asymmetric optical lens of claim 4, wherein the light emission surface includes first and second portions that lie on opposite sides of a first line that divides the light emission surface crosswise in two, wherein the apex is on the first portion of the light emission surface.

6. The asymmetric optical lens of claim 5, wherein the first line is perpendicular to and extends across a second line that divides the light emission surface lengthwise in two.

7. The asymmetric optical lens of claim 6, wherein the second line comprises a longest chord across a profile defined by the light emission surface.

8. The asymmetric optical lens of claim 5, wherein the second portion of the light emission surface on an opposite side of the first line from the first portion projects out from a profile defined by the base surface farther than the first portion of the light emission surface when viewed from a point along a normal from the base surface.

9. The asymmetric optical lens of claim 8, wherein the LED recess is shaped so that the second central light output axis passes through a point in the light emission surface that is on an opposite side of the first line from the LED recess.

10. The asymmetric optical lens of claim 5, wherein the LED recess lies entirely within a profile defined by the first portion when viewed from a point along a normal from the base surface.

11. The asymmetric optical lens of claim 3, wherein a distance between the apex and the base surface along a normal to the base surface is between 10 mm and 11 mm.

12. The asymmetric optical lens of claim 1, wherein a maximum distance across the light emission surface lengthwise is between 17.5 mm and 18.5 mm.

13. The asymmetric optical lens of claim 1, wherein a maximum distance across the light emission surface crosswise is between 15 mm and 16 mm.

14. The asymmetric optical lens of claim 1, wherein the second non-parallel angle is between 40° and 50°.

15. The asymmetric optical lens of claim 1, wherein the second non-parallel angle is approximately 45°.

16. The asymmetric optical lens of claim 1, wherein the second beam of light is wider than the first beam of light by a predetermined amount.

17-19. (canceled)

20. The asymmetric optical lens of claim 1, wherein the asymmetric optical lens is installed between most of the optical membrane and a ground surface.

21. The asymmetric optical lens of claim 1, wherein the asymmetric lens is arranged so that the third central light output axis is pointed generally upwards away from the ground surface.

22. The asymmetric optical lens of claim 1, wherein the optical membrane comprises a three-dimensional shape having a volume.

23. An optical system, comprising:
a plurality of asymmetric optical lens of claim 1; and
a plurality of optical membranes arranged in a matrix, wherein each optical membrane is illuminated with an asymmetric optical lens.
